(19) United States
(12) Patent Application Publication
(10) Pub. No.: US 2011/0160005 A1
(43) Pub. Date: Jun. 30, 2011

(54) Sports Goal Structure with Quick-Release Joint

(76) Inventor: Lung-Chuan Chen, Taichung Hsien (TW)

(21) Appl. No.: 12/647,582

(22) Filed: Dec. 28, 2009

(51) Int. Cl. A63B 63/00; F16C 11/00

(52) U.S. Cl. 473/476; 403/65

(57) ABSTRACT

A quick-release joint for a sports goal structure, the quick-release joint comprises a first tube having first and second ends and a press button formed on the second end thereof; and a second tube having first and second ends and a slot formed on the first end thereof, with the first tube selectively pivoted with respect to the second tube; the quick-release joint is in first, second and third positions selectively, with the press button engaged with the slot and the first and second tubes fixed to each other in the first position of the quick-release joint, with the press button gradually detached from the slot in the second position of the quick-release joint, and with the press button completely detached from the slot and the first tube being able to detach and rotate with respect to the second tube in the third position of the quick-release joint.

### BACKGROUND OF THE INVENTION

1. Field of the Invention

The present invention relates to a sports goal structure, and more particularly to a sports goal structure with a quick-release joint for an easy attachment/disengagment of components of the sports goal structure.

2. Description of the Related Art

Referring to U.S. Pat. No. 6,409,410, it discloses that a coupler for a sport practice net rack includes a first angular tube having a first flat section and a first angular section, and a second angular tube pivotally mounted on the first angular tube and having a second flat section and a second angular section. The second angular section of the second angular tube is disengagably received in the first angular section of the first angular tube.

However, the first and second angular tubes can not rotate with respect to each other so that for folding the sport practice net rack, user has to operate the two adjacent angular tube assemblies in the same time. It is impossible to fold the sport practice net rack by one person operation so that this operation would consume manpower and time.

### SUMMARY OF THE INVENTION

According to the present invention, a sport goal structure consists of a quick-release joint, several secondary joints and first and second upright telescope tubes which are connected to one another via the quick-release joint and the secondary joints. The quick-release joint includes first and second tubes and a joint socket adapted for interconnecting the first and second tubes and pivotally connected to the second tube. A press button is formed on the first tube and selectively engaged with a slot formed on the second tube. While the quick-release joint is in a first position, the first tube is inserted through the joint socket and the second tube and the press button is engaged with the slot so that the first tube is fixed to the second tube. While the quick-release joint is in a second position, the press button is gradually disengaged from the slot. Till the press button is completely disengaged from the slot and the first tube is not fixed to the second tube anymore and disengaged from the second tube, in this moment, the quick-release joint is in a third position. The first tube can be pivoted with respect to the second tube via the joint socket for pilling the first and second upright telescope tubes on one another so that the sport goal structure would be folded easily.

Other advantages and features of the present invention will become apparent from the following descriptions referring to the drawings.

### BRIEF DESCRIPTION OF THE DRAWINGS

The present invention will be described through detailed illustration of the preferred embodiment referring to the drawings.

FIG. 1 is a perspective view of a sport goal structure with according to the preferred embodiment of the present invention.

FIG. 2 is a perspective view of a quick-release joint used for the sport goal structure shown in FIG. 1.

FIG. 3 is an exploded view of the quick-release joint shown in FIG. 2.

FIG. 4 is a cross-sectional view of the quick-release joint shown in FIG. 2.

FIG. 5 is another cross-sectional view of the quick-release joint shown in FIG. 2, illustrating that the quick-release joint is in a first position.

FIG. 6 is a cross-sectional view similar to FIG. 5 but illustrating that the first tube is driven to rotate counterclockwise and the second section of the press button is pressed by the periphery of the slot of the second tube while the quick-release joint is in a second position.

FIG. 7 is a cross-sectional view similar to FIG. 6 but illustrating that the first tube is further driven to rotate counterclockwise until the whole press button is disengaged from the slot of the second tube.

FIG. 8 is a cross-sectional view similar to FIG. 4 but illustrating that while the press button of the first tube is disengaged from the slot, the first tube is moved longitudinally with respect to the second tube and completely disengaged from the second tube.

FIG. 9 is a cross-sectional view similar to FIG. 8 but illustrating that the first tube is driven to rotate with respect to the second tube via the joint socket as a pivot.

FIG. 10 is a cross-sectional view similar to FIG. 9 but illustrating that while the quick-release joint is in a third position, the first tube and the second tube are parallel to each other and connected to each other via the joint socket.

FIG. 11 is a perspective view of the folded sport goal structure shown in FIG. 1 while the quick-release joint is in the third position.

### DETAILED DESCRIPTION OF THE PREFERRED EMBODIMENT

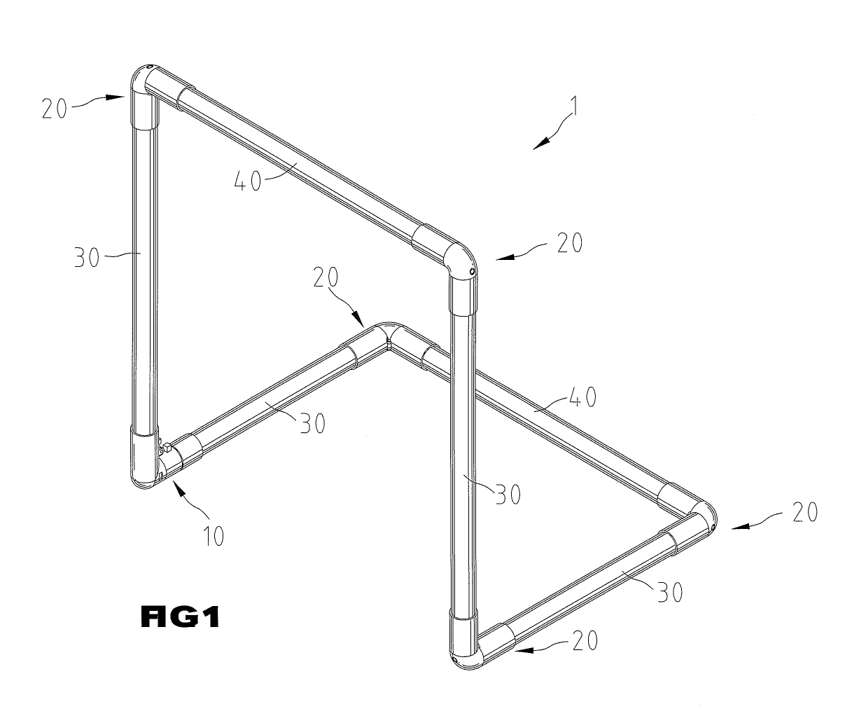

With reference to FIG. 1, it shows that a sport goal structure 1 consists of a quick-release joint 10, several secondary joints 20 and several first and second upright telescope tubes 30 and 40. The quick-release joint 10 and the secondary joints 20 are used to interconnect the first and second upright telescope tubes 30 and 40 and provided at corners of the sport goal structure 1. The secondary joints 20, the first and second upright telescope tubes 30 and 40 are all well-known structures so that it is intended not to give unnecessary details herein.

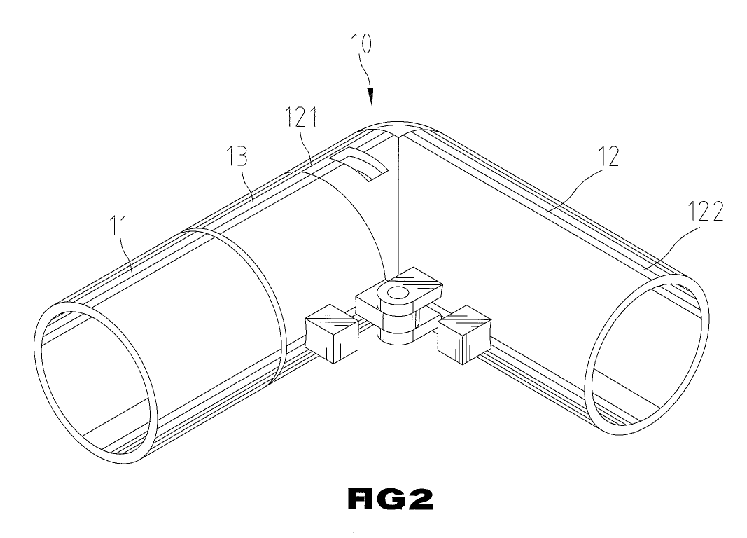

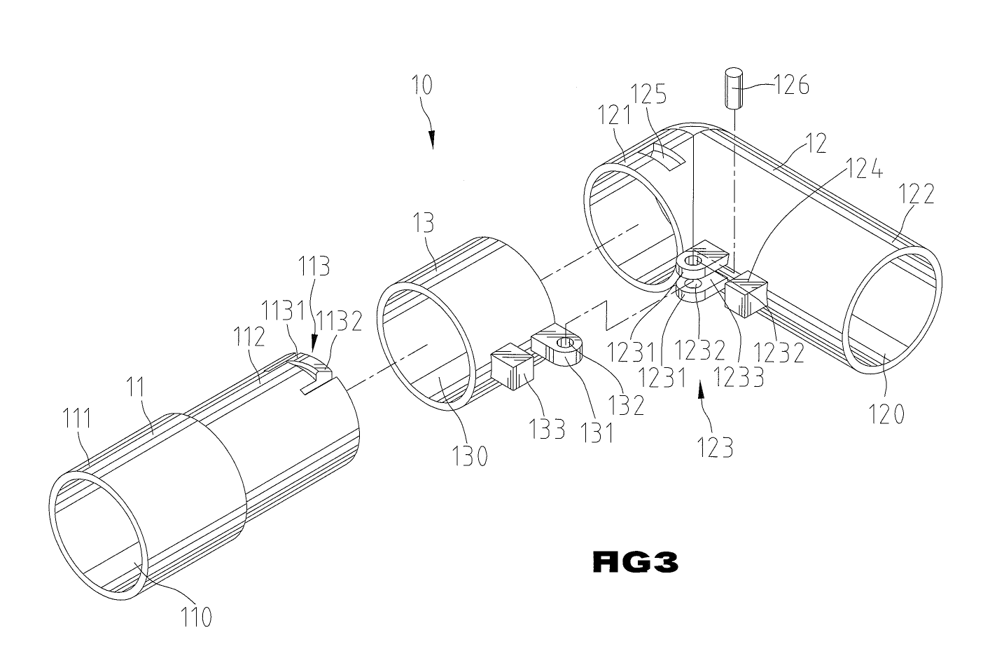

Referring to FIGS. 2 through 5, they show that the quick-release joint 10 includes a first tube 11, a second tube 12 and a joint socket 13 adapted to interconnect the first and second tubes 11 and 12.

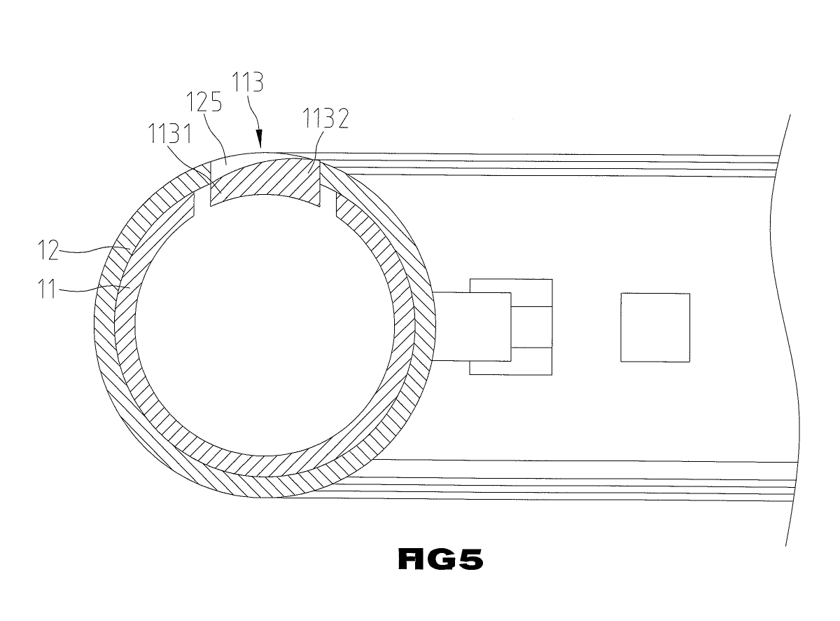

The first tube 11 which is a straight tube has a first end 111, a second end 112 opposite to the first end 111 and a through-hole 110 piercing therethrough longitudinally. The first end 111 of the first tube 11 has an outer diameter larger than an outer diameter of the second end 112 of the first tube 11 and a connection of the first and second ends 111, 112 is preferably stepped. A press button 113 is formed on the periphery of the distal end of the second end 112 and includes first and second sections 1131 and 1132. The press button 113 has a thickness which is gradually increased from the first section 1131 to the second section 1132 with respect to the inner periphery of the first tube 11 (shown in FIG. 5).

The second tube 12 which is an annular tube has a first end 121, a second end 122 being perpendicular to the first end 121 and a through-hole 120 piercing therethrough. An outer diameter and an inner diameter of the second tube 12 are both even from the first end 121 to the second end 122. The outer periphery of the second tube 12 has an outer side and an inner side; a hinge member 123 and a block 124 are provided at the inner side of the outer periphery of the second tube 12 adjacent to the second end 122. The hinge member 123 includes two spaced support ears 1231, two apertures 1232 respectively formed on the support ears 1231 and a space 1233 defined between the support ears 1231. The block 124 is closer to the second end 122 of the second tube 12 than the hinge member 123 and in this case, is in form of a cube. A slot 125 is formed on the top of the first end 121 of the second tube 12 and corresponds to the press button 113 which is selectively engaged therewith.

The joint socket 13 is in form of a straight tube and has a through-hole piercing therethrough, a pivotal ear 131 adjacent to the second tube 12 and inserted to the space 1233 of the hinge member 123, an aperture 132 formed on the pivotal ear 131 and corresponding to the apertures 1232 of the hinge member 123 and a block 133 corresponding to the block 124. The pivotal ear 131 is pivotally connected to the support ears 1231 via a pin 126 which is inserted through the apertures 1232, 132 of the support and pivotal ears 123, 131. The block 133 is selectively in contact with the block 124.

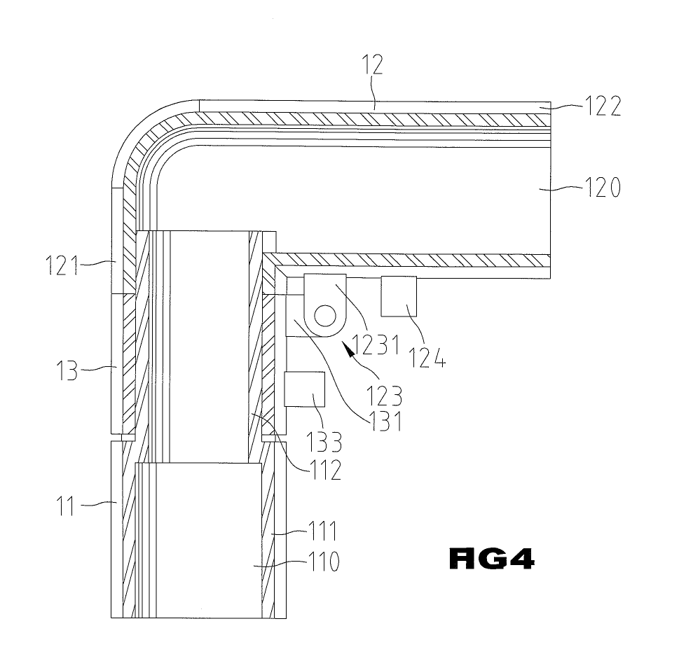

Outer and inner diameters of the joint socket 13 are respectively equal to the outer and inner diameters of the second tube 12 and the first end 111 of the first tube 11. And the outer diameter of the second end 112 of the first tube 11 is equal to the inner diameter of the joint socket 13; hence, while the quick-release joint is in a first position, the second end 112 of the first tube 11 is inserted through the joint socket 13 to the first end 121 and the press button 113 is engaged with the slot 125. While the quick-release joint 10 is in the first position (as shown in FIG. 4), the first tube 11 is perpendicular to the second end 122 of the second tube 12, the pivotal ear 131 is perpendicular to the support ears 1231 and the block 133 is not in contact with the block 124.

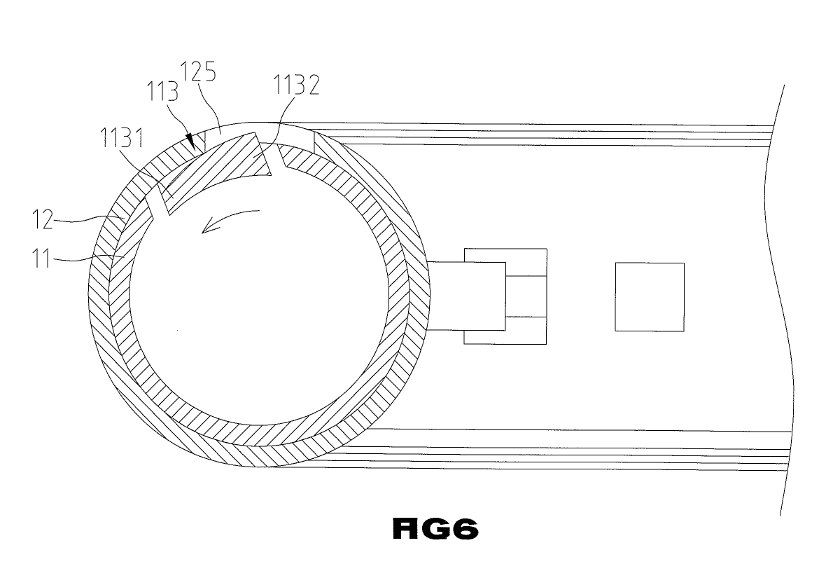

In order to disengag the first tube 11 from the second tube 12, the quick-release joint 10 has to be driven to a second position as shown in FIG. 6. User can hold and rotate the first end 111 of the first tube 11 (not shown) along an arrow direction (shown in FIG. 6), hence, the second end 112 of the first tube 11 is driven to rotate with respect to the second tube 12 and the press button 113 is gradually disengaged from the slot 125. Because the press button 113 is elastic, the inner periphery of the second tube 12 can press the press button 113 inwardly. And the gradually thickness of the press button 113 allows a smoother rotation of the first tube 11.

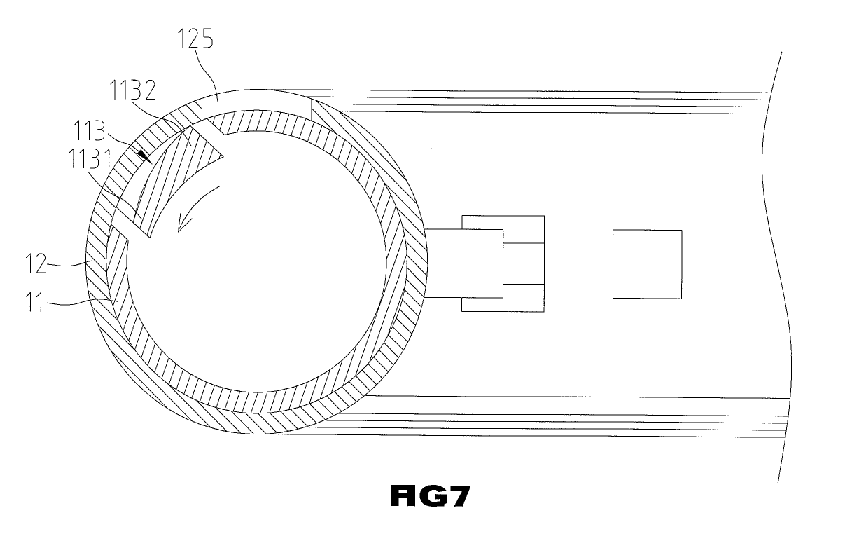

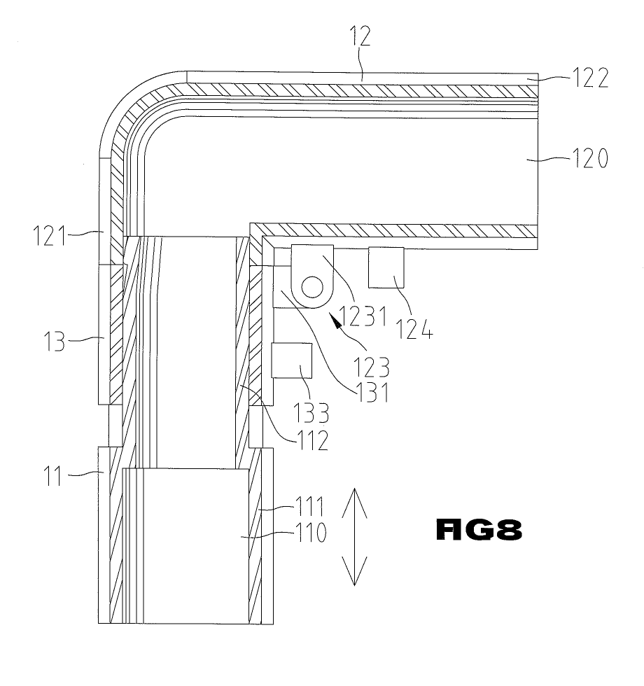

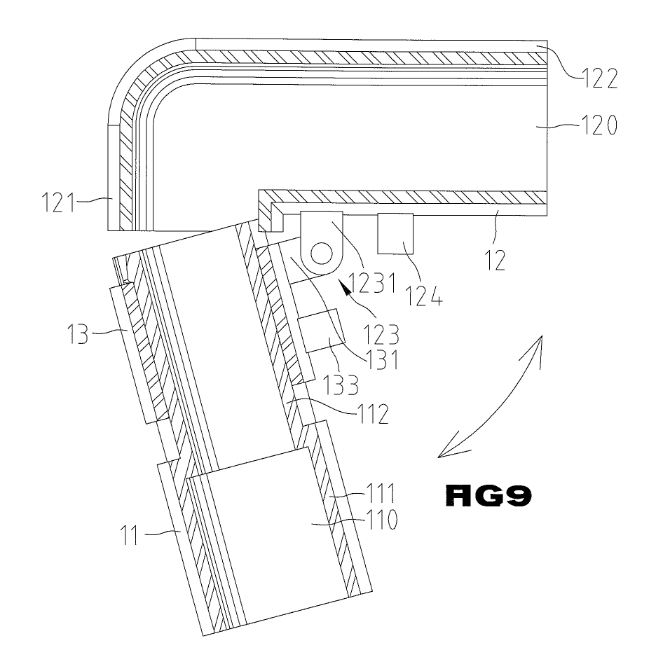

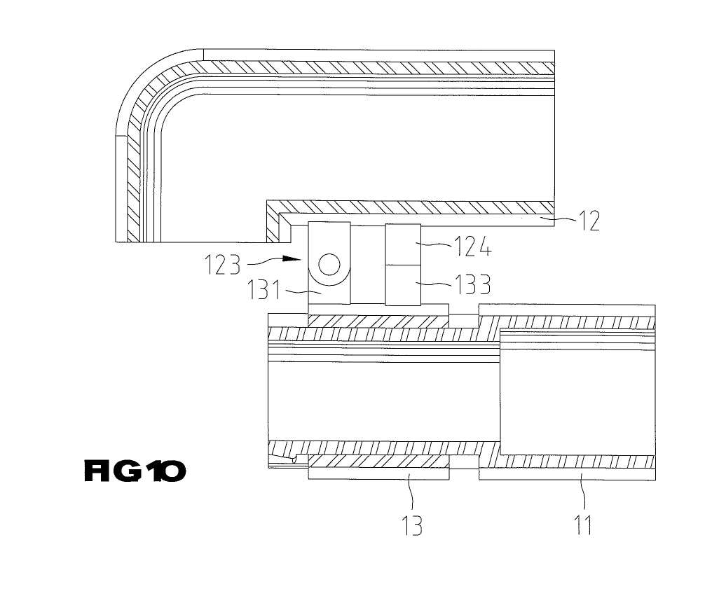

Till the press button 113 is completely disengaged from the slot 125, the quick-release joint 10 is in a third position as shown in FIG. 7. While the quick-release joint 10 is in the third position, the first tube 11 is not fixed to the second tube 12 any more and the second end 112 of the first tube 11 can be disengaged from the first end 121 of the second tube 12 along an arrow direction as shown in FIG. 8. Till the first tube 11 is disengaged from the first end 121 of the second tube 12 completely, user can rotate the first tube 11 with the joint socket 13, which is pivotally connected to the second tube 12, along an arrow direction as shown in FIG. 9 toward the second tube 12. While the top surfaces of the two blocks 133 and 124 of the joint socket 13 and the second tube 12 are abutted against each other, the first and second tubes 11 and 12 are parallel to each other in substance as shown in FIG. 10.

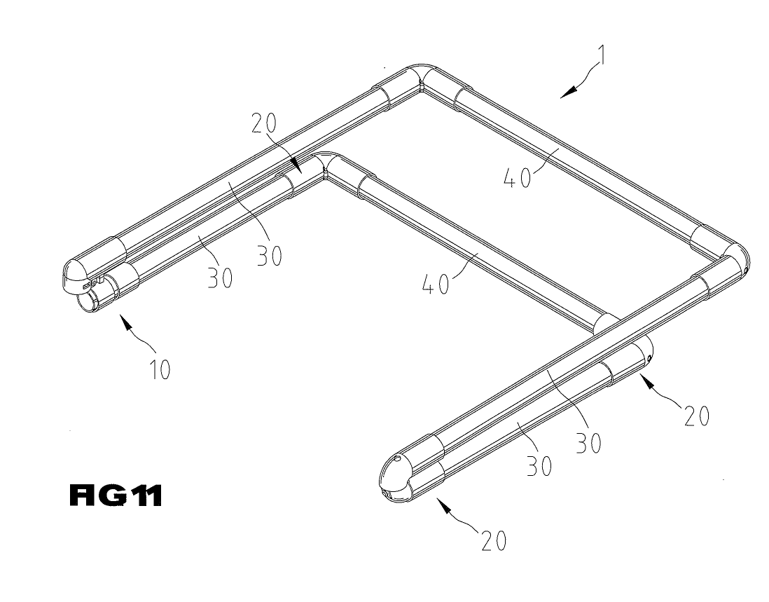

Usually, the sport goal structure 1 of the present invention includes only one quick-release joint 10 provided at one of corners thereof for interconnecting two of the first and second upright telescope tubes 30 and 40. At the other corners of the sport goal structure 1, several the secondary joints 20 are provided to interconnect the other first and second upright telescope tubes 30 and 40. In order to fold the sport goal structure 1 as shown in FIG. 11, user can rotate the first tube 11 of the quick-release joint 10 to drive the press button 113 of the first tube 11 to disengag from the slot 123 of the second tube 12, and then the second end 112 of the first tube 11 is pulled from the first end 121 of the second tube 12 and the first tube 11 is able to pivot with respect to the second tube 12 via the joint socket 13. Finally, the first tube 11 is pivoted to parallel to the second tube 12 and the top of the blocks 133 and 124 are abutted against each other so that the two of the first and second upright telescope tubes 30 and 40 are driven to be parallel to each other. And the secondary joints 20 would be driven to be bent so that the sport goal structure would be folded as shown in FIG. 11. The present invention, user can fold the quick-release joint 10 via one person operation and does NOT need to operate the two adjacent joints in the meanwhile so that it provides an easy, simple and quick fold sport goal structure 1.

While several embodiments of the invention have been shown and described, it will be apparent to those skilled in the art that modifications may be made therein without departing from the scope and spirit of the present invention.

What is claimed is:

1. A quick-release joint for a sports goal structure, the quick-release joint comprising:
a first tube having first and second ends and a press button formed on the second end thereof; and
a second tube having first and second ends and a slot formed on the first end thereof; with the first tube selectively pivoted with respect to the second tube;
wherein the quick-release joint is able to be in first, second and third positions selectively, with the press button engaged with the slot and the first and second tubes fixed to each other in the first position of the quick-release joint, with the press button gradually detached from the slot in the second position of the quick-release joint, and with the press button completely detached from the slot and the first tube being able to detach and rotate with respect to the second tube in the third position of the quick-release joint.

2. The quick-release joint as claimed in claim 1 further comprising a joint socket for interconnecting the second end of the first tube and the first end of the second tubes and pivotally connected to the second tube.

3. The quick-release joint as claimed in claim 2 wherein in the first position of the quick-release joint, the second end of the first tube is inserted through the joint socket and the first end of the second tube; wherein in the third position of the quick-release joint, the second end of the first tube is inserted through the joint socket and detached from the first end of the second tube.

4. The quick-release joint as claimed in claim 2 wherein the joint socket includes a pivotal ear and the second tube includes a hinge member pivotally connected to the pivotal ear of the joint socket.

5. The quick-release joint as claimed in claim 2 wherein the joint socket includes a block and the second tube includes a block, with the top of the two blocks of the joint socket and the second tube being selectively in contact with each other.

6. The quick-release joint as claimed in claim 4 wherein the hinge member includes two spaced support ears, two apertures formed on the two support ears respectively and a space formed between the support ears; wherein the pivotal ear has an aperture corresponds to the two apertures of the hinge member, with the pivotal ear inserted to the space of the hinge member and connected to the support ears via a pin.

7. The quick-release joint as claimed in claim 1 wherein the press button includes a first section and a second section; wherein the press button has a thickness which is gradually increased from the first section to the second section with respect to an inner periphery of the first tube.

8. The quick-release joint as claimed in claim 1 wherein the first end of the first tube has an outer diameter larger than an outer diameter of the second end of the first tube and a connection of the first and second ends is stepped.

9. A sports goal structure comprising:
a quick-release joint comprising
a first tube having first and second ends and a press button formed on the second end thereof; and
a second tube having first and second ends and a slot formed on the first end thereof, with the first tube selectively pivoted with respect to the second tube;
wherein the quick-release joint is able to be in first, second and third positions selectively, with the press button engaged with the slot and the first and second tubes fixed to each other in the first position of the quick-release joint, with the press button gradually detached from the slot in the second position of the quick-release joint, and with the press button completely detached from the slot and the first tube being able to detach and rotate with respect to the second tube in the third position of the quick-release joint;
numbers of secondary joints; and
numbers of first and second upright telescope tubes;
wherein the quick-release joint and the secondary joints are used to interconnect the first and second upright telescope tubes and provided at corners of the sport goal structure.

10. The sports goal structure as claimed in claim 9 whereon the quick-release joint further comprising a joint socket for interconnecting the second end of the first tube and the first end of the second tubes and pivotally connected to the second tube.

11. The sports goal structure as claimed in claim 10 wherein in the first position of the quick-release joint, the second end of the first tube is inserted through the joint socket and the first end of the second tube; wherein in the third position of the quick-release joint, the second end of the first tube is inserted through the joint socket and detached from the first end of the second tube.

12. The sports goal structure as claimed in claim 10 wherein the joint socket includes a pivotal ear and the second tube includes a hinge member pivotally connected to the pivotal ear of the joint socket.

13. The sports goal structure as claimed in claim 10 wherein the joint socket includes a block and the second tube includes a block, with the top of the two blocks of the joint socket and the second tube being selectively in contact with each other.

14. The sports goal structure as claimed in claim 12 wherein the hinge member includes two spaced support ears, two apertures formed on the two support ears respectively and a space formed between the support ears; wherein the pivotal ear has an aperture corresponds to the two apertures of the hinge member, with the pivotal ear inserted to the space of the hinge member and connected to the support ears via a pin.

15. The sports goal structure as claimed in claim 9 wherein the press button includes a first section and a second section; wherein the press button has a thickness which is gradually increased from the first section to the second section with respect to an inner periphery of the first tube.

16. The sports goal structure as claimed in claim 9 wherein the first end of the first tube has an outer diameter larger than an outer diameter of the second end of the first tube and a connection of the first and second ends is stepped.
